(19) United States
(12) Patent Application Publication
(10) Pub. No.: US 2009/0117246 A1
(43) Pub. Date: May 7, 2009

(54) Method for Rejuvenating Aged Food Oils

(76) Inventors: Antonietta Gledhill, Cheshire (GB); Neil MacFarlane, Augst (GB)

Correspondence Address: NIXON & VANDERHYE, PC, 901 NORTH GLEBE ROAD, 11TH FLOOR, ARLINGTON, VA, 22203, US

(21) Appl. No.: 11/988,413

(22) PCT Filed: Jul. 5, 2006
(86) PCT No.: PCT/EP2006/006527

§ 371 Date: Apr. 15, 2008

(30) Foreign Application Priority Data
Jul. 18, 2005 (EP) 05 015 702.3

(51) Int. Cl. C11B 5/00; A23D 7/06

(52) U.S. Cl. 426/545

(57) ABSTRACT

A method of rejuvenating aged food oils or compositions containing PUFAs or such oils by addition of ascorbyl palmitate; such rejuvenated food oils and compositions as well as the use of ascorbyl palmitate in such a rejuvenating process.

Food oils, especially marine food oils, have attracted substantial interest as a source of n-3 long-chain polyunsaturated fatty acids (LC-PUFAs), particularly of eicosapentaenoic acid (EPA) and docohexaenoic acid (DHA), which are of specific dietary significance. These LC-PUFAs contain 5 and 6 double bonds, respectively, which render them prone to atmospheric oxidation accompanied by a fishy taste and smell. The increasing interest in LC-PUFAs has prompted a research into methods of stabilizing fish oils against oxidation and off-flavor development.

It has been known for a long time that refined marine oils are initially free from a taste and smell of fish but that reversion through oxidation occurs rapidly. Many attempts have been made to stabilize the oils by the addition of different anti-oxidants or mixtures thereof. Refined marine oil which has been treated with silica and stabilised with a mixture of lecithin, ascorbyl palmitate and alpha tocopherol in accordance with the procedure described in European Patent Publication 612 346 shows excellent Rancimat stability and good application performance mainly for health food supplements. In dairy applications such as yoghurts and milk drinks, however, this oil develops a strong fish smell and taste. Refined marine oil which has been treated with an adsorbent such as silica and stabilised with 0.1% deodorised rosemary extract (HERBALOX “O”, Kalsec Inc. of Kalamazoo, Mich.) and, respectively, sage extract in accordance with and, respectively, in an analogous manner to the procedure described in European Patent Publication 340 635 has a hereby taste and smell which can be detected in food applications. This hereby taste and smell suppresses the taste and smell of fish. In dairy applications, the use of as little as 0.03% of HERBALOX “O” and, respectively, sage extract in the marine oil results in a very strong hereby taste and smell which prevents the use of this oil in these applications. Such disadvantages have meanwhile been overcome by further developments, e.g., by stabilizing marine oils which have been treated with silica in accordance with the procedure described in European Patent Publication 612 346 over a long period of time without the occurrence of fishy taste and smell by vacuum steam deodorization at a temperature between about 140° C. and about 210° C. in the presence of 0.1-0.4% of deodorised rosemary or sage extract.

However, although oils, especially those rich in PUFAs as marine oils, show good stability over several months, the quality of an oil approximately six months old is believed by customers of lower quality than a fish oil especially when it is intended for use in sensitive food applications and many oils are, therefore, after four months already sent back to the factory to be reworked, i.e., to be stabilized again in the same way as for the first time, This includes addition of the same anti-oxidant mixture originally used which is a costly and time consuming procedure.

In accordance with the present invention it has now surprisingly been found that such procedures can be avoided and can be replaced by a simple procedure of adding ascorbyl palmitate to an aged oil by which procedure the oil is rejuvenated.

The present invention, therefore, relates to a method of rejuvenating an aged food oil or a composition containing PUFAs or such oil which method is characterized by the addition of ascorbyl palmitate to such oil or composition.

The invention further relates to aged PUFA containing food oils or compositions rejuvenated by the addition of ascorbyl palmitate.

The invention further relates to the use of ascorbyl palmitate for rejuvenating aged PUFA containing food oils and to ascorbyl palmitate and its preparations for the use as rejuvenating agents for such oils and compositions.

The terms “PUFA” or “LC-PUFA” is used in the present specification and claims in the sense generally known to the person skilled in the art and relates to polyunsaturated fatty acids individually or as mixtures, prepared synthetically or isolated, concentrated and/or purified from natural sources. The terms relate to free acids, their salts, mono-, di- or triglycerides or other esters, e.g., ethyl esters, obtainable, e.g., from glycerides by transesterification. PUFAs of preferred interest in the context of the present invention are n-3 and n-6 PUFAs, espec. EPA, DPA, DHA, GLA and ARA, preferably of food-grade quality, separately or in mixtures, preferably in the form of their triglycerides, especially as components of oil obtained from marine animals, preferably from fish or from plants and their seeds or by fermentation of microorganisms. They can be stabilized and/or deodorized by methods known in the art, e.g., by addition of antioxidants, emulsifiers, spices or herbs, such as rosemary or sage extracts.

Food oils of microorganism, plant or animal origin which are used or intended for use as food or in food or feed applications and which are preferably refined, stabilized and/or deodorized by procedures are well-known in the art. Particularly transformed microorganisms and plants can be rich sources of such oils or PUFAs.

Examples of such oils are animal oils, e.g., fish oils, especially from salmon, cod, herring or mackerel, from other marine animals, vegetable oils, e.g. from soya, sunflower, rape, maize, olive or peanut, or reconstituted glycerides

Food oils containing PUFAs are oils which naturally contain PUFAs or to which PUFAs have been added, especially in order to increase their nutritional values. Examples of food oils from sources which naturally contain PUFAs and the PUFA contents of which may have been increased by concentration during the process of their manufacture are oils which are commercially available and known under the trade mark ROPUFA®. Examples of such oils are ROPUFA® 30 n-3 EPA oil; ROPUFA® n-3 DHA oil; ROPUFA® 30 n-3 FOOD OIL; ROPUFA® 30 n-3 INF Oil; ROPUFA® 30 n-3 Food Oil Emulsion and ROPUFA® 75 n-3 EE Oil.

Food oils characterized by a high n-3 PUFA content are those derived from marine animals, preferably from fish, and have been stabilized with tocopherols or tocotrienols (natural mixtures or synthetically prepared, preferably α-tocopherols), if desired together with other antioxidants and/or deodorants, such as ascorbyl palmitate or citric acid esters and/or sage or rosemary extract.

Compositions containing oils or oil compositions comprise emulsions (oil-in-water and water-in-oil), preferably oil-in-water emulsions, e.g. milk of any kind and in fresh or pasteurized form or products derived from milk including but not limited to yoghurts, butter, cheese, etc. Examples of compositions containing PUFAs are also margarines which have been fortified with PUFAs.

The term “rejuvenating” defines a process which confers to an aged PUFA-containing oil or composition the sensory quality of a product, which has been freshly prepared or is stored only for a short time. Such rejuvenated products would, in a sensory test, be classified as having no or only very slightly fishy taste.

The term “aged” in connection with food oils or compositions containing them used in the present patent application is relative and defines oils and compositions which, after having been manufactured and stored for a certain time, show signs of deterioration as a whole or of some of their components, especially if they have been in contact with oxygen and if these deteriorations have a negative impact on their sensory quality. Such deterioration, however, may also occur in oils and compositions which have been packaged under an inert atmosphere and not been exposed to oxygen for a long time, e.g. up to more than a year. Examples are oils in their original package which are 6 to 16 months old. Such deterioration can be determined by analytical methods and by sensory tests which are still among the most sensitive methods.

Analytical methods useful in the determination of such deteriorations are well-known in the art and comprise
GC-MS headspace technique and HPLC
determination of the PUFA content, especially of n-3 PUFAs
determination of Rancimat stability
determination of antioxidants and stabilizing ingredients

Sensory tests by trained test panel people are also commonly used and well-known such as the FAST test according to which the taste of a sample is classified on a scale from 1=not fishy to 7=extremely fishy.

The rejuvenating process of an aged oil or oil composition, i.e. the addition of ascorbyl palmitate will normally be initiated when a decrease of the sensory quality has been determined which can be done either by sensory tests themselves or by using analytically methods identifying the increase of components which increase inversely correlates with a decrease of quality. The appropriate time for the start of such a rejuvenating process may be only a few months after manufacture of the oil and may thus start after two, three, four, five or six months or after a longer shelf-live and can be repeated up to several times depending upon the material to be rejuvenated and its storage conditions.

Ascorbyl palmitate is a well-known compound, commercially available, which itself is stable until a temperature of 107° C. The ascorbic acid part thereof may be in enantiomeric or racemic form. Preferred is the L-ascorbic acid form. Synonyms for ascorbyl palmitate are 2,3-didehydro-L-threo-hexono-1,4-lactone-6-palmitate and 6-palmitoyl-3-keto-L-gulofuranolactone.

Other stable esters of ascorbic acid which are also well-known and commercially available and which are good antioxidants are encompassed by the term “ascorbyl palmitate” in connection with the present invention.

Ascorbyl palmitate can be added as such, i.e. in solid form, to the oil or composition to be rejuvenated where appropriate and be distributed and solved by intensive mixing.

In a preferred embodiment, however, ascorbyl palmitate is used in form of a solution, preferably in form of an oil- and water-mixable solution, most preferably in form of an alcoholic solution. Examples are glycolic and alkanolic solutions, especially propylene glycolic and ethanolic solutions.

The concentration of such solution can vary over a wide range. It is normally in the range of from 0 to 125 mg/ml, preferably in the range of from 50 to 100 mg/ml.

The rejuvenating amount of ascorbyl palmitate to be added to the aged oil or composition once or several times is in the range of from about 0 to about 1000 ppm, preferably from about 100 to about 500 ppm. For the commercial ROPUFA® oils, e.g., the most appropriate rejuvenating amount of ascorbyl palmitate is from about 100 to about 500 ppm if the solution is to be clear at room temperature.

After the rejuvenating process the oils or compositions may be stored again for several months under normal storage conditions, preferably under inert gas atmosphere and at low temperatures.

The following Experiments demonstrate the rejuvenating effect of ascorbyl palmitate on PUFA containing aged oils and compositions in accordance with the present invention.

### Experiments to Test the Ascorbyl Palmitate Rejuvenating Activity.

ROPUFA® 30 n-3 food oil: stabilised with 200 ppm ascorbyl palmitate, 500 ppm dl-α-tocopherol and 4000 ppm rosemary extract. Deodorised at 190° C. Age: 14 months
1. The experiment consisted of a 14 months old oil under three different scenarios (the oil still contained any remaining antioxidants added at the start):
   a. Oil as is (not rejuvenated)
   b. Oil as is+solid ascorbyl palmitate
   c. Oil as is+liquid ascorbyl palmitate
2. The oil+solid ascorbyl palmitate was heated to approx. 95° C. under vacuum until at least 90% had been dissolved.
3. The liquid ascorbyl palmitate addition was facile and was achieved by dissolving ascorbyl palmitate in absolute ethanol to yield a 10% solution and then blending with the oil.
4. The three oils were then tasted.
5. The three oils were also trialled in a milk at T=0, and the three milk products were tasted at concentrations of 0.2% and 1.0%

All oils were analysed for their anti-oxidant content (HPLC) and their Rancimat stability. The oils were then stirred into milk (no sodium ascorbate was added) at concentrations of 0.2 and 1%.

### Results:

TABLE 1
Ascorbyl palmitate content & Rancimat stability of the oils used in the
milks

| | Ascorbyl | Rancimat |
|---|---|---|
| | palmitate (ppm) | stability (110° C.) |
| Oil a | 42.0 | 2.8 |
| Oil b (Rot. Evap.) | 200.7 | 3.2 |
| Oil c (10% in abs. | 256.6 | 3.3 |
| EtOH) | | |

Table 5 shows that over the storage period of 14 months, Oil a has lost 75% ascorbyl palmitate. The tocopherol content was analysed and this was found to be still present at its initial concentration of 500 ppm. The presence of an increased amount ascorbyl palmitate makes the oil more stable in the Rancimat.

### Milk Taste

Oils a, b and c were added to milk at room temperature. The milk was tested immediately by a taste panel of two trained persons.

TABLE 2

| | Comments from the lab taste panel | |
|---|---|---|
| Oils in milk | 0.2% oil in Milk | 1.0% oil in Milk |
| Oil a | No fish smell. | Some fish smell. |
| | Slight fish taste initially, | Fish taste (but not rancid), |
| | but disappears very | slightly stronger than at |
| | quickly | 0.2% but not 5 times as |
| | | strong. Some aftertaste |
| Oil b | No fish smell. | No fish smell. |
| | Slight fish, initial taste | Stronger fish taste than |
| | stronger, however | 0.2%, difficult to say |
| | disappears completely | whether fishier than 1.0% |
| | | with Oil a. Some aftertaste |
| Oil c | No fish smell. | No fish smell. |
| | No fish taste, milk has a | Fish taste, not as bad as Oils |
| | sweet pleasant taste | a and b. Taste disappears |
| | | more quickly than of the |
| | | others at 1.0% |

At a concentration of 0.2% in milk the liquid ascorbyl palmitate dissolved in oil did not taste fishy at all, but in the other two slight fish could be tasted.

Addition of solid ascorbyl palmitate did not perform as well and this is believed to be due to damage of the oil while bringing the ascorbyl palmitate into solution.

1. A method of rejuvenating an aged food oil or a composition containing PUFAs or such oil which method is characterized by the addition of ascorbyl palmitate to such oil or composition.

2. The method of claim 1 wherein the food oil is a refined oil.

3. The method of claim 1 wherein the food oil is a stabilized commercial food oil.

4. The method of claim 1 wherein the ascorbyl palmitate is added in form of a solution.

5. The method of claim 4 wherein the ascorbyl palmitate is added in form of an alkanolic or glycolic solution, especially ethanolic or propylene glycolic solution.

6. Rejuvenated aged PUFA containing food oils or compositions which have been rejuvenated by a method as claimed in claim 1.

7. The use of ascorbyl palmitate in a process of rejuvenating an aged food oil or a composition containing PUFA or such oil as claimed in claim 1.

8. Ascorbyl palmitate to be used for or whenever used as a means for rejuvenating an aged food oil or a composition containing PUFA or such oil.

9. Ascorbyl palmitate as claimed in claim 8 in the form of a solution.

10. Ascorbyl palmitate as claimed in claim 8 in the form of an alkanolic or glycolic solution, especially ethanolic or propylene glycolic solution.
